(19) United States
(12) Patent Application Publication
(10) Pub. No.: US 2010/0093937 A1
(43) Pub. Date: Apr. 15, 2010

(54) POLAR GROUP FUNCTIONALIZED CO-POLYMERS

(76) Inventors: Hoang T. Pham, Lake Jackson, TX (US); Richard F. Fibiger, Midland, MI (US); Eddy I. Garcia-Meitin, Angleton, TX (US); Jin Zhao, Midland, MI (US)

Correspondence Address: The Dow Chemical Company, Intellectual Property Section, P.O. Box 1967, Midland, MI, 48641-1967, US

(21) Appl. No.: 12/515,597

(22) PCT Filed: Nov. 12, 2007
(86) PCT No.: PCT/US07/84399

§ 371 Date: Dec. 22, 2009

Related U.S. Application Data
(60) Provisional application No. 60/872,883, filed on Dec. 5, 2006.

(51) Int. Cl. C08L 23/08; C08F 210/02; C08F 8/00; C08F 8/32

(52) U.S. Cl. 525/193; 526/348; 525/240; 525/194

(57) ABSTRACT

The invention relates to a polar group functionalized copolymer useful to prepare a nanocomposite polymer and to the nanocomposite polymer, wherein the polar group functionalized copolymer useful to prepare a nanocomposite polymer and the nanocomposite polymer are as defined in the specification.

### BACKGROUND OF THE INVENTION

The instant invention relates to nanocomposite polymers and more specifically to polar group functionalized co-polymers used to prepare nanocomposite polymers.

Polymers reinforced with delaminated cation-exchanging layered materials are termed “nanocomposite polymers” in the art when at least one dimension of the delaminated cation-exchanging layer material is less than one hundred nanometers. Nanocomposite polymers generally have enhanced mechanical property characteristics vs. conventionally filled polymers, for example, increased tensile or flex modulus while (in theory) maintaining or even increasing impact toughness. Typically, the thickness of a single layer of a delaminated cation-exchanging material is in the range of one to two nanometers while the length and width of such layer can be in the range of, for example, one hundred to one thousand nanometers. Transmission electron photomicrographs of nanocomposite polymers typically show a dispersion of multiple layer units of the cation-exchanging layered material in the polymer matrix. However, it is generally desired to achieve a high degree of delamination of the cation-exchanging layered material. Ideally the degree of such delamination is so extensive that only single layer units of the cation-exchanging layered material are present. If the cation-exchanging layered material is not sufficiently delaminated, then the mechanical property improvement of the polymer composite will usually be no better than if conventional micron sized filler is dispersed in the polymer.

Cation-exchanging layered materials are typically treated with “onium” ions to facilitate delamination when blended with polar polymers such as polyamide polymers as described, for example, in U.S. Pat. No. 5,973,053, herein fully incorporated by reference. As discussed in the '053 patent, when such onium ion treated materials are blended with non-polar polymers (such as polyethylene or polypropylene) essentially no delamination occurs. However, as disclosed in the '053 patent, by incorporating more than ten percent of a polar group modified polymer as a “compatibalizer” with a non-polar polymer, it is possible to achieve a moderate degree of delamination and a limited degree of physical property improvement. Thus, there remains a need for a compatabilizer which results in a greater degree of physical property improvement for non-polar nanocomposite polymers.

### SUMMARY OF THE INVENTION

The instant invention is a solution, at least in part, to the above-mentioned problems. The instant invention is a copolymer based compatabilizer having specific requirements. Nanocomposite polymers of the instant invention have improved strength as well as surprisingly improved impact characteristics.

More specifically, the instant invention is a polar group functionalized copolymer useful to prepare a nanocomposite polymer, the polar group functionalized copolymer comprising: more than fifty weight percent propylene monomer, from one tenth to thirty weight percent ethylene monomer and/or one or more alpha olefin monomers, the polar group functionalized copolymer having a solubility parameter difference relative to atactic polypropylene homopolymer of an absolute value of from 0.01 to 0.3 (i.e. the solubility parameter difference is in the range of −0.3 to −0.01 and +0.01 to +0.3), the weight average molecular weight of the polar group functionalized copolymer being greater than twenty five thousand grams per mole, the ratio of the average number of monomer units in the polar group functionalized copolymer to the average number of polar groups of the polar group functionalized copolymer being in the range of from 20 to 1000.

In another embodiment, the instant invention is a polar group functionalized copolymer useful to prepare a nanocomposite polymer, the polar group functionalized copolymer comprising: more than fifty weight percent propylene monomer, from one tenth to thirty weight percent ethylene monomer and/or one or more alpha olefin monomers, the weight average molecular weight of the polar group functionalized copolymer being greater than twenty five thousand grams per mole, the ratio of the average number of monomer units in the polar group functionalized copolymer to the average number of polar groups of the polar group functionalized copolymer being in the range of from 20 to 1000, the polar group functionalized copolymer also meeting a test, the test requiring the formation of insoluble domains when a molten mixture consisting of from one to forty weight percent of the polar group functionalized copolymer and from ninety-nine to sixty weight percent atactic polypropylene homopolymer of essentially the same weight average molecular weight as the polar group functionalized copolymer is cooled to solidify the mixture.

In a related embodiment, the instant invention is a nanocomposite polymer, comprising from one tenth to twenty five weight percent of an onium treated layered cation exchanging material, from one tenth to ninety-nine and nine tenths percent of a polar group functionalized copolymer of the instant invention and a polymer or copolymer comprising one or more alpha olefins.

### DETAILED DESCRIPTION

Delaminated or exfoliated cation exchanging layered materials (such as delaminated 2:1 layered silicate clays) can be used as reinforcing filler in a polymer system. Such polymer systems are known as “nanocomposites” when at least one dimension of the delaminated cation exchanging layered material is less than one hundred nanometers. Typically, transmission electron microscopy of a prior art nanocomposite polymer shows a few or no single layers of delaminated cation exchanging layered material but rather mostly multiple layer stacks of cation exchanging layered material. Never-the-less, prior art nanocomposite polymers generally have enhanced mechanical property characteristics vs. conventionally filled polymers. For example, prior art nanocomposite polymers most often have increased modulus characteristics.

Cation exchanging layered materials are often treated with an organic cation (usually an “onium”) to facilitate delamination of the cation exchanging layered material when it is blended with a polymer (see, for example U.S. Pat. No. 5,973,053). Conventionally, the layered material is “under exchanged”, “fully exchanged” or “overexchanged”, i.e., the exchangeable cations of the layered material are less than, equal to or more than replaced by an equivalent of onium ions.

The term “cation exchanging layered material” means layered oxides, sulfides and oxyhalides, layered silicates (such as Magadiite and kenyaite) layered 2:1 silicates (such as natural and synthetic smectites, hormites, vermiculites, illites, micas, and chlorites).

The cation exchange capacity of a cation exchanging layered material describes the ability to replace one set of cations (typically inorganic ions such as sodium, calcium or hydrogen) with another set of cations (either inorganic or organic). The cation exchange capacity can be measured by several methods, most of which perform an actual exchange reaction and analyzing the product for the presence of each of the exchanging ions. Thus, the stoichiometry of exchange can be determined on a mole percent basis. It is observed that the various cation exchanging layered materials have different cation exchange capacities which are attributed to their individual structures and unit cell compositions. It is also observed for some cation exchanging layered materials that not all ions of the exchanging type are replaced with the alternate ions during the exchange procedure.

The term “onium” means a cation that contains at least one hydrocarbon radical. Examples of oniums include, without limitation thereto, phosphonium, arsonium, sulfonium, oxonium, imidazolium, benzimidazolium, imidazolinium, protonated amines, protonated amine oxides, protonated betaines, ammoniums, pyridiniums, aniliniums, pyrroliums, piperidiniums, pyrazoliums, quinoliniums, isoqunoliniums, indoliums, oxazoliums, benzoxazoliums, and quinuclidiniums. A typical example of an onium is a quaternary ammonium compound of formula R₁R₂R₃R₄N⁺, wherein at least one of R₁, R₂, R₃ or R₄ contains ten or more carbon atoms. The term “onium” also includes a protonated amine which can be prepared, for example and without limitation thereto, by the contact of the cation exchanging layered material with an acid followed by contact of the cation exchanging layered material with an organic amine to protonate the amine

The instant invention is a polar group functionalized copolymer useful to prepare a nanocomposite polymer, the polar group functionalized copolymer comprising: more than fifty weight percent propylene monomer, from one tenth to thirty weight percent ethylene monomer and/or one or more alpha olefin monomers, the polar group functionalized copolymer having an absolute value of a solubility parameter difference relative to atactic polypropylene homopolymer of less than 0.3 and greater than 0.01, the weight average molecular weight of the polar group functionalized copolymer being greater than twenty five thousand grams per mole, the ratio of the average number of monomer units in the polar group functionalized copolymer to the average number of polar groups of the polar group functionalized copolymer being in the range of from 20 to 1000. The solubility parameter difference relative to atactic polypropylene homopolymer is determined according to the teachings of Reichart et al, Macromolecules 1998, 31, 7886-7894, herein fully incorporated by reference. Preferably the absolute value of the solubility parameter difference relative to atactic polypropylene homopolymer is from less than 0.2, more preferably less than 0.1. Preferably, the absolute value of a solubility parameter difference relative to atactic polypropylene homopolymer is greater than 0.02, more preferably greater than 0.03. It should be understood that when such a difference is zero, then the instant invention is not effective. However, it is believed that such a difference of even plus or minus more than 0.01 is effective.

In another embodiment, the instant invention is a polar group functionalized copolymer useful to prepare a nanocomposite polymer, the polar group functionalized copolymer comprising: more than fifty weight percent propylene monomer, from one tenth to thirty weight percent ethylene monomer and/or one or more alpha olefin monomers, the weight average molecular weight of the polar group functionalized copolymer being greater than twenty five thousand grams per mole, the ratio of the average number of monomer units in the polar group functionalized copolymer to the average number of polar groups of the polar group functionalized copolymer being in the range of from 20 to 1000, the polar group functionalized copolymer also meeting a test, the test requiring the formation of insoluble domains when a molten mixture consisting of from one to forty weight percent of the polar group functionalized copolymer and from ninety-nine to sixty weight percent atactic polypropylene homopolymer of essentially the same weight average molecular weight as the polar group functionalized copolymer is cooled to solidify the mixture. The insoluble domains of polar group functionalized copolymer are apparent upon transmission electron microscopic examination. Although applicants do not intend to be held thereto, it is believed that the formation of the insoluble domains of the polar group functionalized copolymer in the matrix polymer increases the degree of delamination of a cation-exchanging layered material in a non-polar matrix polymer such as polyethylene or polypropylene.

Transmission electron microscopic examination to determine the insoluble domains of polar group functionalized copolymer in the atactic polypropylene homopolymer can be performed according to the following procedure. Samples blocks are cryopolished and prestained with RuO₄ vapors for three hours at room temperature. The staining solution is prepared by weighing 0.2 grams of ruthenium (III) chloride hydrate into a glass jar with a screw lid and adding 10 milliliters of 5.25% aqueous sodium hypochlorite. The cryopolished sample blocks are placed in the glass jar adhered to a glass microscope slide by way of double sided adhesive tape in order to suspend the blocks about 1 inch above the staining solution. Sections of the stained blocks of approximately 70 nanometers in thickness are cut at room temperature using a diamond knife microtome and placed on 400 mesh virgin copper grids for examination by transmission electron microscopy. This procedure can also be used to determine insoluble domains in a nanocomposite polymer of the instant invention.

The following procedure can be used to determine the degree of delamination of the onium treated layered cation exchanging material of a nanocomposite polymer of the instant invention. Sections of unstained sample blocks are prepared using a microtome equipped with a cryosectioning chamber. Sections of approximately 70 nanometer thickness are cut using a diamond knife at −120° C. and placed on 400 mesh virgin copper grids for examination by transmission electron microscopy.

The polar group of the polar group functionalized copolymer is typically maleic anhydride grafted to the copolymer chain. However, the polar group can be, without limitation thereto, any carboxylate (or carboxylic acid), hydroxyl, amide, amine, siloxane, ammonium (and more generally an onium) or even a metal oxide. The relative amounts of the monomer units and polar groups in the polar group functionalized copolymer of the instant invention can be determined by methods known in the art such as nuclear magnetic resonance spectroscopy and infrared spectroscopy. The exchange capacity of the cation-exchanging layered material exchanged for the onium is preferably in the range of from fifty to one hundred percent. More preferably, the exchange capacity of the cation-exchanging layered material exchanged for the onium is in the range of from eighty to one hundred percent. The molecular weight of the polar group functionalized copolymer of the instant invention can be determined by size exclusion chromatography.

The polar group functionalized copolymer can be any form, such as and without limitation thereto, a block copolymer, a random copolymer and mixtures thereof. The polar group functionalized copolymer typically comprises maleated copolymer and preferably consists essentially of maleated copolymer. The ethylene monomer content of the polar group functionalized copolymer is preferably in the range of from one to fifteen weight percent. The ethylene monomer content of the polar group functionalized copolymer is more preferably in the range of from one to twelve weight percent. The ethylene monomer content of the polar group functionalized copolymer is yet more preferably in the range of from one to eight weight percent. The weight average molecular weight of the polar group functionalized copolymer is preferably greater than one hundred thousand grams per mole. On the other hand, the weight average molecular weight of the polar group functionalized copolymer is preferably less than five hundred thousand grams per mole. Most preferably, the weight average molecular weight of the polar group functionalized copolymer is in the range of from one hundred and eighty thousand to three hundred and fifty thousand grams per mole.

In a related embodiment, the instant invention is a nanocomposite polymer, comprising from one tenth to twenty five weight percent of an onium treated cation exchanging layered material, from one tenth to ninety-nine and nine tenths percent of the polar group functionalized copolymer and a polymer or copolymer comprising one or more alpha olefins. Preferably, the nanocomposite polymer comprises from one tenth to twenty five weight percent of an onium treated layered cation exchanging material, from one tenth to ninety-nine and nine tenths percent of the polar group functionalized copolymer and a polymer or copolymer consisting essentially of one or more alpha olefins. The amount of onium treated layered cation exchanging material is preferably in the range of from two to fifteen weight percent of the nanocomposite polymer. The amount of polar group functionalized copolymer is preferably in the range of from three to ten weight percent of the nanocomposite polymer. The weight ratio of the polar group functionalized copolymer to the amount of onium treated cation exchanging layered material used in a nanocomposite polymer of the instant invention is preferably in the range of from 0.1 to 5 (more preferably in the range of from 0.2 to 4 and most preferably in the range of from 0.3 to 3). The onium treated cation exchanging layered material is preferably montmorillonite or fluoromica treated with an onium comprising a quaternary ammonium compound.

The polar group functionalized copolymer of the instant invention can be made by any method used to prepare the prior-art polar group functionalized homopolymers. For example, maleated propylene/ethylene copolymer can be made by blending maleic anhydride and an organic peroxide with molten propylene/ethylene copolymer in the same manner as the prior art maleated polypropylene homopolymer. Propylene/ethylene copolymers are commercially available from, for example and without limitation thereto, The Dow Chemical Company, Midland, Mich. U.S. Pat. No. 6,960,635, herein fully incorporated by reference, describes, for example and without limitation thereto, the preparation of preferred propylene/ethylene copolymers for such use in the instant invention.

Nanocomposite polymers of the instant invention can be made, for example and without limitation thereto, by blending the polar group functionalized copolymer of the instant invention with an onium treated cation-exchanging layered material and a polymer or copolymer comprising one or more alpha olefins in, for example and without limitation thereto, a polymer extruder or a polymer blender. Examples of a polymer or copolymer comprising one or more alpha olefins include, without limitation thereto, polyethylene, polypropylene and polypropylene/polyethylene copolymer. Nanocomposite polymer of the instant invention can comprise a nanocomposite thermoplastic olefin. Nanocomposite polymers of the instant invention can be made, for example and without limitation thereto, by blending the polar group functionalized copolymer of the instant invention with an onium treated cation-exchanging layered material and a dissolved polymer or copolymer followed by removal of the solvent of the polymer at a temperature sufficient to melt the polymer. Thus, in general, a nanocomposite polymer of the instant invention can be made by any method wherein the polymer is solidified from a melted condition.

### COMPARATIVE EXAMPLE 1

145 grams of polypropylene/ethylene random copolymer (grade 6D83K from Dow) and 7.5 g of maleated polypropylene homopolymer (0.62 wt % maleic anhydride, Weight Average molecular weight=314,000) are blended at 180° C. and 60 rpm. After 2.5 minutes of blending, 15.0 grams of onium treated montmorillonite (Claytone HY from Southern Clay Products) and 25 grams of polypropylene/ethylene random copolymer (grade 6D83K from Dow) is added, followed by an additional 22.5 grams of polypropylene/ethylene random copolymer (grade 6D83K from Dow). After a total of 4 minutes of blending, the temperature is lowered to 170° C. and the mixing rate is raised to 120 rpm. After a total of 11 minutes of blending, the resulting nanocomposite polymer is removed, cooled, ground into small pieces, and devolatilized under vacuum at 80° C. for 16 hr. The nanocomposite polymer is injection molded into test bars and tested for flex modulus and notched izod impact at room temperature. The average flex modulus of the testing is 216,000 pounds per square inch. The average notched izod impact test is 2.5 foot-pounds per inch. Transmission electron microscopic examination of the nanocomposite polymer shows a limited degree of delamination of the onium treated montmorillonite.

### COMPARATIVE EXAMPLE 2

145 grams of polypropylene/ethylene random copolymer (grade 6D83K from Dow) and 7.0 g of maleated polypropylene homopolymer (0.75 wt % maleic anhydride, Weight Average molecular weight=149,000) are blended at 180° C. and 60 rpm. After 2.5 minutes of blending, 15.0 grams of onium treated (dimethyl dehydrogenated tallow ammonium chloride) fluoromica (Somasif ME100) and 25 grams of polypropylene/ethylene random copolymer (grade 6D83K from Dow) is added, followed by 22.5 grams of polypropylene/ethylene copolymer (INSPiRE 112 brand from Dow). After a total of 4 minutes of blending, the temperature is lowered to 170° C. and the mixing rate is raised to 120 rpm. After a total of 11 minutes of blending, the resulting nanocomposite polymer is removed, cooled, ground into small pieces, and devolatilized under vacuum at 80° C. for 16 hr. The nanocomposite polymer is injection molded into test bars and tested for flex modulus and notched izod impact at room temperature. The average flex modulus of the testing is 213,000 pounds per square inch. The average notched izod impact test is 1.9 foot-pounds per inch. Transmission electron microscopic examination of the nanocomposite polymer shows a limited degree of delamination of the onium treated fluoromica.

### EXAMPLE 1

One hundred twenty five grams of polypropylene/ethylene copolymer made according to the teachings of U.S. Pat. No. 6,960,635, having an ethylene content of about 5% by weight, a propylene content of about 95% by weight and a melt flow index of 2 and a weight average molecular weight of 319,000) is blended at 100° C. and 30 rpm. 7.5 g of maleic anhydride is dry mixed with 50 g of polypropylene/ethylene copolymer and added to the blend followed by 20 g of polypropylene/ethylene copolymer. After a total of 6 minutes of blending 1 g of additional maleic anhydride, 1.06 g of dibenzoyl peroxide and 17 g of polypropylene/ethylene copolymer are added to the blend. After a total of 8 minutes of blending, the temperature is raised to 115° C. and the blending rate is increased to 60 rpm. After a total time of 15 minutes, the temperature is raised to 130° C. and the blending rate is increased to 100 rpm. The maleated copolymer is removed, cooled, ground into small pieces, and devolatized under vacuum at 80° C. for 16 hr. A compression molded film of the reaction product was analyzed for graft level (weight percent maleic anhydride=0.75) by infra red spectroscopy and the molecular weight determined by high temperature gel permeation chromatography (Weight Average molecular weight=226,000).

### EXAMPLE 2

One hundred forty five grams of polypropylene/ethylene impact copolymer (INSPiRE 112 from Dow) and 7.5 g of maleated polypropylene/ethylene copolymer (Example 1) are introduced into a blender at 180° C. and 60 rpm. After 2.5 min of mixing 15.0 g of Claytone HY (Southern Clay Products) is mixed with 25 grams of INSPiRE 112 (Dow) polypropylene homopolymer followed by 22.5 grams INSPiRE 112. After a total of 4 min the temperature is lowered to 170° C. and the mixing rate is increased to 120 rpm. After a total lime of 11 minutes the nanocomposite polymer is removed, cooled, ground into small pieces, and devolatilized under vacuum at 80° C. for 16 hr. The nanocomposite polymer is injection molded into test bars and tested for flex modulus and notched izod impact at room temperature. The average flex modulus of the testing is 237,000 pounds per square inch. The average notched izod impact test is 15.1 foot-pounds per inch. Transmission electron microscopic examination of the nanocomposite polymer shows a high degree of delamination of the onium treated montmorillonite and the presence of microscopic domains of the maleated copolymer in the matrix polymer.

### EXAMPLE 3

One hundred forty five grams of polypropylene/ethylene impact copolymer (INSPiRE 112 from Dow) and 7.5 g of maleated polypropylene/ethylene copolymer (0.62 Wt % maleic anhydride, Weight Average molecular weight 314,000) are introduced into a blender at 180° C. and 60 rpm. After 2.5 min of mixing 15.0 g of onium treated fluoromica (Somasif ME100) is mixed with 25 grams of INSPiRE 112 (Dow) polypropylene homopolymer followed by 22.5 grams INSPiRE 112. After a total of 4 min the temperature is lowered to 170° C. and the mixing rate is increased to 120 rpm. After a total lime of 11 minutes the nanocomposite polymer is removed, cooled, ground into small pieces, and devolatilized under vacuum at 80° C. for 16 hr. The nanocomposite polymer is injection molded into test bars and tested for flex modulus and notched izod impact at room temperature. The average flex modulus of the testing is 251,000 pounds per square inch. The average notched ixod impact test is 18.3 foot-pounds per inch. Transmission electron microscopic examination of the nanocomposite polymer shows a high degree of delamination of the onium treated montmorillonite and the presence of microscopic domains of the maleated copolymer in the matrix polymer.

### EXAMPLE 4

Sixty six point nine (66.9) grams of high crystalline polypropylene homopolymer (9934 from Amoco), 65.3 grams ethylene/propylene elastomer (Affinity 8180 from Dow), and 18.9 grams of maleated propylene/ethylene copolymer (0.72 Wt % maleic anhydride, Weight Average molecular weight 246,000) are blended at 180° C. and 60 rpm. After 2.5 min of mixing 18.9 grams of onium treated fluoromica (Somasif ME100) dry mixed with 25 grams of high crystalline polypropylene homopolymer (9934 from Amoco) are added followed by 20 grams of high crystalline polypropylene homopolymer (9934 from Amoco). After a total of 5 minutes the temperature is lowered to 170° C. and the mixing rate is increased to 120 rpm. After a total time of 17 minutes the resulting thermoplastic olefin nanocomposite is removed, cooled, ground into small pieces, and devolalilized under vacuum at 80° C. for 16 hr. The nanocomposite is injection molded into test bars and tested for flex modulus at room temperature and notched izod impact at 0° C. The average flex modulus of the testing is 156,000 pounds per square inch. The average notched izod impact test is 12.4 foot-pounds per inch. Transmission electron microscopic examination of the nanocomposite thermoplastic olefin shows a high degree of delamination of the onium treated fluoromica and the presence of microscopic domains of the maleated copolymer in the matrix polypropylene homopolymer.

### EXAMPLE 5

One hundred fifty-four (154) grams of high crystalline polypropylene homopolymer (D404 from Dow Chemical), 7.5 grams of maleated propylene/ethylene copolymer (0.63 Wt % maleic anhydride, Weight Average molecular weight 253,000) are blended at 180° C. and 60 rpm. After 2 min of mixing 14.5 grams of onium treated fluoromica (Somasif ME100) dry mixed with 25 grams of high crystalline polypropylene homopolymer (D404 from Dow Chemical) are added followed by 14 grams of high crystalline polypropylene homopolymer (D404 from Dow Chemical). After a total of 4 minutes the temperature of the ThermoHaake mixer is lowered to 170° C. and the mixing rate is increased to 120 rpm After a total time of 11 minutes the resulting high crystalline polypropylene nanocomposite is removed, cooled, ground into small pieces, and devolatilized under vacuum at 80° C. for 16 hours. The nanocomposite is injection molded into test bars and tested for flex modulus and notched izod impact at room temperature. The average flex modulus of the testing is 358,000 pounds per square inch. The average notched izod impact test is 1.1 foot-pounds per inch. Transmission electron microscopic examination after staining the high crystalline polypropylene nanocomposite for three hours with ruthenium tetroxide shows a good global dispersion of small stacks and tactoids of the onium treated fluoromica. At higher magnifications, it was evident that diffuse, patch-like regions were present around many of the nanofiller stacks. The darker contrast associated with these regions suggest a lower density material believed to be the maleated propylene/ethylene copolymer. These regions are not present in virgin high crystalline polypropylene homopolymer.

### EXAMPLE 6

### Preparation of High Density Polyethylene (HDPE) Nanocomposites

Maleated polypropylene/ethylene copolymer (0.6 wt % maleic anhydride) and onium treated fluoromica (Somasif ME100) are vacuum-dried at 80° C. for more than 12 hours. Dow CONTINUUM™ DGDA-2490 NT—melt index=0.08, density=0.95 HDPE (189.2 g) and the vacuum-dried maleated polypropylene/ethylene copolymer (10.75 g) are dry-blended, and about 75% of the dry-blended material is loaded into a Haake batch mixer equipped with 250 mL mixing head [PolyLab Rheomix 3000P, Thermo Haake] that is preheated at 150° C. and spinning 60 rpm, and mixed for 2 minutes. Then the vacuum-dried onium treated fluoromica (15.05 g) and the rest of the dry-blended material are sequentially loaded into the Haake batch mixer and mixed at 150° C. and 60 rpm for up to a total mixing time of 4 minutes. Then, the temperature and speed of mixing are changed to 140° C. and 80 rpm, and mixing is continued for an additional 6 minutes. The resulting HDPE nanocomposite is removed from the Haake batch mixer and cooled to room temperature. Portions of the HDPE nanocomposite are ground cryogenically, then injection molded into test bar samples. The test bar samples are tested for flex modulus and notched izod impact at room temperature. The HDPE nanocomposite has a flex modulus of 220 kilopounds per square inch (kpsi) and a room temperature notched izod of 4.9 foot-pounds per inch.

For comparison, the same test bar sample processing history is also applied to a sample of the neat HDPE resin (Dow CONTINUUM™ DGDA-2490 NT). The neat HDPE resin has a flex modulus of 192 kpsi and a room temperature notched izod of 13.7 foot-pounds per inch.

### CONCLUSION

In conclusion, it should be readily apparent that although the invention has been described above in relation with its preferred embodiments, it should be understood that the instant invention is not limited thereby but is intended to cover all alternatives, modifications and equivalents that are included within the scope of the invention as defined by the following claims.

1. A polar group functionalized copolymer useful to prepare a nanocomposite polymer, the polar group functionalized copolymer comprising: more than fifty weight percent propylene monomer units, about five weight percent ethylene monomer units and/or one or more alpha olefin monomer units, the polar group functionalized copolymer having a solubility parameter difference relative to atactic polypropylene homopolymer of an absolute value of from 0.01 (calories per cubic centimeter)^{1/2} to 0.3 (calories per cubic centimeter)^{1/2}, the weight average molecular weight of the polar group functionalized copolymer being greater than twenty five thousand grams per mole, the ratio of the average number of monomer units in the polar group functionalized copolymer to the average number of polar groups of the polar group functionalized copolymer being in the range of from 20 to 1000.

2. The polar group functionalized copolymer of claim 1, wherein the absolute value of the solubility parameter difference is less than 0.2 (calories per cubic centimeter)^{1/2}.

3. A polar group functionalized copolymer useful to prepare a nanocomposite polymer, the polar group functionalized copolymer comprising: more than fifty weight percent propylene monomer units, about five weight percent ethylene monomer units and/or one or more alpha olefin monomer units, the weight average molecular weight of the polar group functionalized copolymer being greater than twenty five thousand grams per mole, the ratio of the average number of monomer units in the polar group functionalized copolymer to the average number of polar groups of the polar group functionalized copolymer being in the range of from 20 to 1000, the polar group functionalized copolymer also meeting a test, the test requiring the formation of insoluble domains when a molten mixture consisting of from one to forty weight percent of the polar group functionalized copolymer and from ninety-nine to sixty weight percent atactic polypropylene homopolymer of essentially the same weight average molecular weight as the polar group functionalized copolymer is cooled to solidify the mixture.

4-32. (canceled)

33. A polar group functionalized copolymer useful to prepare a nanocomposite polymer, the polar group functionalized copolymer comprising: more than fifty weight percent propylene monomer units, from one tenth to thirty weight percent ethylene monomer units and/or one or more alpha monomer units, the polar group functionalized copolymer having a solubility parameter difference relative to atactic polypropylene homopolymer of an absolute value of less than 0.1 (calories per cubic centimeter)^{1/2} and greater than 0.01 (calories per cubic centimeter)^{1/2}, the ratio of the average number of monomer units in the polar group functionalized copolymer to the average number of polar groups of the polar group functionalized copolymer being in the range of from 20 to 1000, wherein the weight average molecular weight of the polar group functionalized copolymer is in the range of from one hundred and eighty thousand grams per mole to three hundred and fifty thousand grams per mole.

34. The polar group functionalized copolymer of claim 33, wherein the polar group functionalized copolymer is selected from the group consisting of a block copolymer, a random copolymer and mixtures thereof.

35. The polar group functionalized copolymer of claim 33, wherein the polar group functionalized copolymer comprises maleated copolymer.

36. The polar group functionalized copolymer of claim 33, wherein the polar group functionalized copolymer consists essentially of maleated copolymer.

37. The polar group functionalized copolymer of any of claims 33-36, wherein the ethylene monomer content of the polar group functionalized copolymer is in the range of from one to fifteen weight percent.

38. The polar group functionalized copolymer of claim 37, wherein the ethylene monomer content of the polar group functionalized copolymer is in the range of from one to eight weight percent.

39. The polar group functionalized copolymer of claim 33, wherein the polar group functionalized copolymer comprises hydroxylated copolymer.

40. The polar group functionalized copolymer of claim 33, wherein the polar group functionalized copolymer comprises aminated copolymer.

41. A nanocomposite polymer, comprising from one tenth to twenty five weight percent of an onium treated layered cation exchanging material; from one tenth to ninety-nine and nine tenths percent of the polar group functionalized copolymer of claim 1; and a polymer or copolymer comprising one or more alpha olefins.

42. A nanocomposite polymer, comprising from one tenth to twenty five weight percent of an onium treated layered cation exchanging material; from one tenth to ninety-nine and nine tenths percent of the polar group functionalized copolymer of claim 3; and a polymer or copolymer comprising one or more alpha olefins.

43. A nanocomposite polymer, comprising from one tenth to twenty five weight percent of an onium treated layered cation exchanging material; from one tenth to ninety-nine and nine tenths percent of the polar group functionalized copolymer of claim 33; and a polymer or copolymer comprising one or more alpha olefins.

44. The nanocomposite polymer of claim 43, wherein the onium treated layered cation exchanging material is montmorillonite or fluoromica treated with an onium comprising a quaternary ammonium compound.

45. The nanocomposite polymer of claim 44, wherein the quaternary ammonium compound is of formula R₁R₂R₃R₄N⁺, wherein at least one of R₁, R₂, R₃ or R₄ contains ten or more carbon atoms.

46. The nanocomposite polymer of claim 43, wherein the onium is a protonated amine.

47. The nanocomposite polymer of claim 43, wherein the nanocomposite polymer has a notched Izod impact at room temperature of greater than about 12 foot-pounds per inch.

48. The nanocomposite polymer of claim 43, wherein the ethylene monomer unit content of the polar group functionalized copolymer is about five weight percent.
